(19) United States
(12) Patent Application Publication
(10) Pub. No.: US 2025/0180500 A1
(43) Pub. Date: Jun. 5, 2025

(54) WEAR SENSING APPARATUS

(71) Applicant: TURUN YLIOPISTO, Turun yliopisto (FI)

(72) Inventors: Arto PELTOLA, Turun Yliopisto (FI); Tatu PELTOLA, Turun Yliopisto (FI); Jarno SALONEN, Turun Yliopisto (FI); Ermei MÄKILÄ, Turun Yliopisto (FI); Pasi SAARENMAA, Turun Yliopisto (FI); Kalle HENRIKSSON, Turun Yliopisto (FI)

(21) Appl. No.: 18/843,428

(22) PCT Filed: Feb. 28, 2023
(86) PCT No.: PCT/FI2023/050113

§ 371 Date: Sep. 3, 2024

(30) Foreign Application Priority Data
Mar. 2, 2022 (FI) 20225188
May 31, 2022 (FI) 20225477

(51) Int. Cl. G01N 27/04; G01N 27/22

(52) U.S. Cl. CPC G01N 27/041; G01N 27/22

(57) ABSTRACT

The present disclosure relates to a wear sensing apparatus that allows a wear rate of a wear surface to be efficiently monitored not only at macroscales but also at microscales and nanoscales. For this purpose, the apparatus comprises a multi-layered substrate formed by an array of plate-like conductors alternating with an array of dielectric layers. Each of the plate-like conductors is coupled to a control unit. When wear occurs on a wear surface of the multi-layered substrate, the control unit determines a wear rate by monitoring and analysing a capacitance and/or a resistance between each two adjacent plate-like conductors. The control unit then outputs the wear rate to a user. In some embodiments, the control unit may use the monitored capacitances and/or the monitored resistance to determine whether at least two plate-like conductors of the array of plate-like conductors have been brought into a direct electric contact during the wear, and output a corresponding signal to the user.

### CROSS-REFERENCE TO RELATED APPLICATIONS

The present application claims priority from the Finnish Patent Application No. 20225188, filed with the Finnish Patent and Registration Office on Mar. 2, 2022, entitled “WEAR SENSING APPARATUS”, the entire disclosure of which is hereby incorporated by reference.

### TECHNICAL FIELD

The present disclosure relates generally to techniques for monitoring characteristics of machine or tool components and other materials which are exposed to mechanical wear. More particularly, the present disclosure relates to an apparatus for sensing the mechanical wear of such components or materials not only at macroscales but also at microscales and nanoscales.

### BACKGROUND

Mechanical wear is a typical physical phenomenon observed in a variety of mechanical systems, such, for example, as industrial, agricultural and other machines or tools, tribology testing equipment, surface finishing equipment, etc. The mechanical wear consists in the damaging and gradual removal of material from contacting solid surfaces of machine or tool components. In particular, the relative motion of two contacting solid surfaces can cause damage to one or both of them. This damage manifests itself as a progressive loss of material, i.e., as material particles detached from the contacting solid surface(s). The detached material particles are also referred to as wear debris.

Given this, it is usually necessary to monitor a degree of wear (also referred to as a wear rate or wear depth) associated with a particular mechanical system. This monitoring may be performed by manual inspection or by using wear sensors. In some situations where the manual inspection is physically impossible or requires significant machine or equipment downtime, the wear sensors are the only viable option to use.

The existing wear sensors are usually based on using an electrical circuit of resistive or capacitive elements that are connected in parallel on or under a wear surface. When wear occurs on such a wear sensor, the resistive or capacitive elements (typically, surface mount resistors or capacitors) are electrically decoupled from the circuit one by one, thereby changing a total measurable electrical characteristic (e.g., total measurable resistance or capacitance) of the circuit.

The existing wear sensors are good to monitor the degree of wear at macroscales but may not be as effective at microscales and nanoscales due to the above-described sensor design.

### SUMMARY

This summary is provided to introduce a selection of concepts in a simplified form that are further described below in the detailed description. This summary is not intended to identify key features of the present disclosure, nor is it intended to be used to limit the scope of the present disclosure.

The objective of the present disclosure is to provide a wear sensing apparatus that allows a wear rate of a wear surface to be efficiently monitored (in real time) not only at macroscales but also at microscales and nanoscales.

The objective above is achieved by the features of the independent claim in the appended claims. Further embodiments and examples are apparent from the dependent claims, the detailed description and the accompanying drawings.

According to an aspect, a wear sensing apparatus is provided. The apparatus comprises a multi-layered substrate having a wear surface. The multi-layered substrate comprises an array of plate-like conductors and an array of dielectric layers. The array of plate-like conductors and the array of dielectric layers alternate with each other. The wear surface is formed by edges of plate-like conductors of the array of plate-like conductors and edges of dielectric layers of the array of dielectric layers. The apparatus further comprises a control unit coupled to each plate-like conductor of the array of plate-like conductors. The control unit is configured, when wear occurs on the wear surface of the multi-layered substrate, to monitor a capacitance and/or a resistance between each two adjacent plate-like conductors of the array of plate-like conductors and use the monitored capacitances and/or the monitored resistances to determine a wear rate of the multi-layered substrate. The control unit is further configured to output the wear rate to a user. The apparatus thus configured may be efficiently used to monitor the wear rate not only at macroscales but also at microscales and nanoscales, without having to inspect the wear surface with any additional equipment, e. g., a microscope. Furthermore, the apparatus thus configured may allow one to observe or detect scratches when wear occurs on the wear surface of the multi-layered substrate. On top of that, the apparatus thus configured may be used to determine a relative change in a moisture content on the wear surface (especially, during a polishing process).

In one exemplary embodiment, the control unit is further configured to use the monitored capacitances and/or the monitored resistances to determine whether at least two plate-like conductors of the array of plate-like conductors have been brought into a direct electric contact during the wear. If the at least two plate-like conductors of the array of plate-like conductors have been brought into the direct electric contact during the wear, the control unit is further configured to output a signal (e.g., visual, acoustic, vibration, or any combination thereof) to the user. In response to such a signal, the user may terminate or properly tune a wear process. Furthermore, this functionality of the control unit may allow the apparatus to be used not only for monitoring the wear but also for detecting the occurrence of smearing (surface deformation or plastic deformation). The possibility of detecting the occurrence of smearing is especially important when processing materials (e.g., during cutting, grinding and polishing processes).

In one exemplary embodiment, each plate-like conductor of the array of plate-like conductors extends perpendicular to the wear surface. Such perpendicular arrangement of the plate-like conductors (and, consequently the dielectric layers) is easy to implement.

In one exemplary embodiment, the array of plate-like conductors has an equal inter-conductor spacing. In other words, each dielectric layer of the array of dielectric layers has an equal width. The equal inter-conductor spacing may allow the user to monitor the smearing effect in percentage terms, as well as to detect the occurrence of big scratches when the wear occurs on the wear surface of the multi-layered structure. For example, if there are 100 plate-like conductors extending perpendicular to the wear surface of the multi-layered substrate, and if the capacitance and/or resistance measurements show that 32 (e.g., randomly spaced) of these 100 plate-like conductors have been brought into direct electric contact during the wear, then the amount of the smearing effect may be set to 32%. Furthermore, if these 32 (short-circuited) plate-like conductors are closely arranged in one part of the multi-layered substrate (e.g., they are adjacent to each other at the left edge of the multi-layered substrate), this may also be an indication of a big scratch occurred in that part of the multi-layered substrate.

In one exemplary embodiment, the array of conductors has a varying inter-conductor spacing. In other words, each dielectric layer of the array of dielectric layers has a different (e.g., gradually increasing or decreasing) width. The varying inter-conductor spacing may allow the user to monitor the smearing effect in length units (e.g., in microns), as well as to detect the occurrence of big scratches when the wear occurs on the wear surface of the multi-layered structure. More specifically, the amount of the smearing effect may be considered as the widest short-circuited 20 inter-conductor spacing. For example, if the inter-conductor spacings of 1 μm, 5 μm and 10 μm are all short-circuited, but the inter-conductor spacings of 20 μm and 30 μm are not short-circuited, then the amount of the smearing effect is 10 μm. Moreover, if the inter-conductor spacing of 30 μm is short-circuited, then this may also be an indication of a big scratch occurred in the multi-layered substrate.

In one exemplary embodiment, the inter-conductor spacing ranges from about 5 nm to about 10 mm (or varies within any subranges of this spacing range, such, for example, as from about 10 nm to about 9 mm, from about 20 nm to about 8 mm, from about 30 nm to about 7 mm, from about 40 nm to about 6 mm, from about 50 nm to about 5 mm, etc.). By using this spacing range, it is possible to monitor the smearing effect and/or the occurrence of scratches at an acceptable level of granularity.

In one exemplary embodiment, the array of plate-like conductors comprises a first subarray of plate-like conductors and a second subarray of plate-like conductors. The first subarray of plate-like conductors and the second subarray of plate-like conductors are non-overlapping. In this embodiment, the first subarray of plate-like conductors has an equal inter-conductor spacing and the second subarray of plate-like conductors has a varying inter-conductor spacing. By using such inter-conductor spacings for the first and second subarrays of plate-like conductors, it is possible to provide different levels of granularity (resolution) for the monitored smearing effect during the wear.

In one exemplary embodiment, the inter-conductor spacing of each of the first subarray of plate-like conductors and the second subarray of plate-like conductors ranges from about 5 nm to about 10 mm (or varies within any subranges of this spacing range, such, for example, as from about 10 nm to about 9 mm, from about 20 nm to about 8 mm, from about 30 nm to about 7 mm, from about 40 nm to about 6 mm, from about 50 nm to about 5 mm, etc.). By using this spacing range, it is possible to monitor the smearing effect and/or the occurrence of scratches at an acceptable level of granularity.

In one exemplary embodiment, the array of conductors comprises a first subarray of plate-like conductors and a second subarray of plate-like conductors. The first subarray of plate-like conductors and the second subarray of plate-like conductors are non-overlapping. In this embodiment, the first subarray of plate-like conductors has a first equal inter-conductor spacing and the second subarray of plate-like conductors has a second equal inter-conductor spacing. The second equal inter-conductor spacing is different from the first equal inter-conductor spacing. By using such inter-conductor spacings for the first and second subarrays of plate-like conductors, it is possible to provide different levels of granularity (resolution) for the monitored smearing effect during the wear.

In one exemplary embodiment, each of the first equal inter-conductor spacing and the second equal inter-conductor spacing ranges from about 5 nm to about 10 mm (or varies within any subranges of this spacing ranges, such, for example, as from about 10 nm to about 9 mm, from about 20 nm to about 8 mm, from about 30 nm to about 7 mm, from about 40 nm to about 6 mm, from about 50 nm to about 5 mm, etc.). By using this spacing range, it is possible to monitor the smearing effect and/or the occurrence of scratches s at an acceptable level of granularity.

In one exemplary embodiment, each plate-like conductor of the array of plate-like conductors is made of a ductile material (e.g., gold, silver, aluminum, copper, titanium, nickel, any alloy thereof, as well as any conducting polymer, conducting co-polymer, or any semiconductor material belonging to groups III-V of Mendeleev's periodic table, etc.). The ductile material may be advantageous especially when the apparatus is also used for detecting and monitoring the smearing effect. Moreover, ductile material may simplify the fabrication of different (e.g., in width and/or shape) plate-like conductors on the multi-layered substrate, if required.

In one exemplary embodiment, each dielectric layer of the array of dielectric layers is made of glass, silicon, SiO₂, epoxy, a polymer, a semiconductor, ceramics, SiC, a nonconducting polymer, a nonconducting co-polymer, or any combination thereof. These materials have proper dielectric properties, thereby allowing no direct electric contact between the plate-like conductors.

In one exemplary embodiment, each plate-like conductor of the array of plate-like conductors has a width ranging from about 5 nm to about 10 mm. It should be noted the width of each plate-like conductor may vary within any subranges of this range, such, for example, from about 10 nm to about 9 mm, from about 20 nm to about 8 mm, from about 30 nm to about 7 mm, from about 40 nm to about 6 mm, from about 50 nm to about 5 mm, etc. By using these conduction dimensions, it is possible to efficiently monitor the wear rate (and the smearing effect, if present).

In one exemplary embodiment, the apparatus further comprises at least one of an accelerometer and a gyroscope on at least one surface of the multi-layered substrate that is other than the wear surface. By using these sensing devices, the user may obtain different measurement data associated with the wear of the multi-layered substrate (and the smearing effect, if present) and properly control the whole process based on the measurement data.

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 shows a schematic block diagram of a wear sensing apparatus in accordance with a first exemplary embodiment;

FIG. 2 shows a schematic block diagram of a wear sensing apparatus in accordance with a second exemplary embodiment;

FIG. 3 shows a schematic block diagram of a wear sensing apparatus in accordance with a third exemplary embodiment;

FIG. 4 shows a schematic block diagram of a wear sensing apparatus in accordance with a fourth exemplary embodiment;

FIG. 5 shows a schematic block diagram of a wear sensing apparatus in accordance with a fifth exemplary embodiment;

FIGS. 6A-6C schematically show how resistance measurements may be used to monitor the smearing effect that manifests as metallic bridges across dielectric layers in the apparatus of FIG. 5;

FIG. 7 shows how the apparatus of FIG. 5 may be implemented in the form of a button-like structure; and

FIG. 8 shows how the button-like structure of FIG. 7 may be used in a polishing process.

### DETAILED DESCRIPTION

Various embodiments of the present disclosure are further described in more detail with reference to drawings. the accompanying However, the present disclosure may be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, is which disclosed herein, irrespective of whether this embodiment is implemented independently or in concert with any other embodiment of the present disclosure. For example, the apparatus disclosed herein may be implemented in practice using any numbers of the embodiments provided herein. Furthermore, it should be understood that any embodiment of the present disclosure may be implemented using one or more of the elements presented in the appended claims.

The word “exemplary” is used herein in the meaning of “used as an illustration”. Unless otherwise stated, any embodiment described herein as “exemplary” should not be construed as preferable or having an advantage over other embodiments. Any positioning terminology, such as “left”, “right”, “top”, “bottom”, “above” “below”, “upper”, “lower”, etc., may be used herein for convenience to describe one element's or feature's relationship to one or more other elements or features in accordance with the figures. It should be apparent that the positioning terminology is intended to encompass different orientations of the apparatus disclosed herein, in addition to the orientation(s) depicted in the figures. an As example, if one imaginatively rotates the apparatus in the figures 90 degrees clockwise, elements or features described as “left” and “right” relative to other elements or features would then be oriented, respectively, “above” and “below” the other elements or features. Therefore, the positioning terminology used herein should not be construed as any limitation of the present disclosure.

Although the numerative terminology, such as “first”, “second”, etc., may be used herein to describe various embodiments, elements or features, these embodiments, elements or features should not be limited by this numerative terminology. This numerative terminology is used herein only to distinguish one embodiment, element or feature from another embodiment, element or feature. Thus, a first embodiment discussed below could be called a second embodiment, and vice versa, without departing from the teachings of the present disclosure.

As used in the embodiments disclosed herein, mechanical wear (hereinafter referred to as wear for short) may refer to the continuing loss of a material from the surface of a solid body due to a mechanical action, such, for example, as the contact and relative movement of a solid or fluid counter body. In general, the term “wear” may be used for both an abrasion or attrition process and its consequences. The surface subjected to the wear is herein referred to as a wear surface, and a direction in which the wear occurs (i.e., the direction away from the wear surface) is herein referred to as a wear path. The wear thus defined may be observed in different mechanical systems relating to tribology, tool wear monitoring, surface finishing, machine wear monitoring, etc. It should be also noted that the wear may be accompanied by scratches, cracks and relief, as well as by the so-called smearing effect which may be a big problem in metallographic sample preparation from ductile materials.

As used in the embodiments disclosed herein, smearing may refer to a surface deformation/damage/wear mechanism of a material (especially, ductile materials), which is caused by plastic deformation where the material is pushed across a wear surface but, at the same time, the pushed material remains attached to the wear surface. Correspondingly, smear may be considered as a thin layer of such surface deformation/damage/wear on the surface of a prepared sample. It is commonly developed during mid to late preparation stages (e.g., diamond polishing and oxide polishing). For example, critical factors for the formation of the smearing in polishing processes are an applied load, a lubrication amount, rotation speeds and directions of a polishing plate and a sample plate, properties of a polishing pad, the amount and properties of a polishing liquid, etc.

The exemplary embodiments disclosed herein provide a technical solution that allows mitigating or even eliminating the drawbacks of the prior art which are mentioned in the description part “Background”. In particular, the technical solution disclosed herein relates to a wear sensing apparatus that allows a wear rate of one or more wear surfaces to be efficiently monitored not only at macroscales but also at microscales and nanoscales. For this purpose, the apparatus comprises an array of elongated planar conductors extending parallel to each other on a patterned surface of a dielectric substrate. Each of the conductors is coupled to a control unit. When wear occurs on at least one wear surface of the dielectric substrate which is adjacent to the patterned surface, the control unit determines a wear rate by monitoring and analysing a capacitance and/or a resistance between each two adjacent conductors. The control unit then outputs the wear rate to a user. In a particular embodiment, the control unit may use the monitored capacitances and/or the monitored resistances to determine whether at least two conductors of the array of conductors have been brought into a direct electric contact during the wear, and output a corresponding signal to the user.

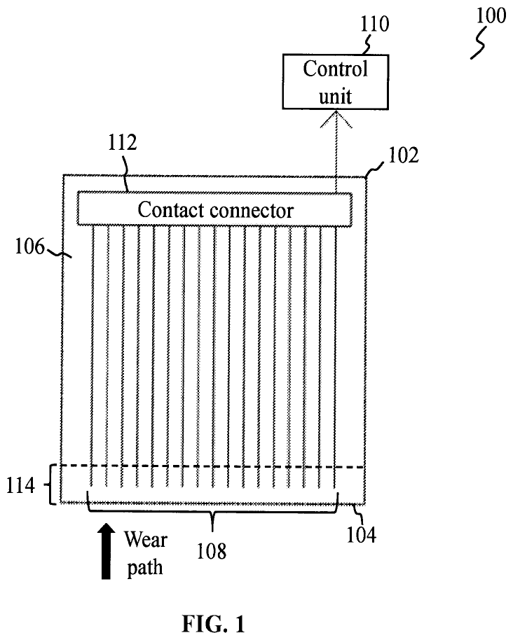

FIG. 1 shows a schematic block diagram of a wear sensing apparatus 100 in accordance with a first exemplary embodiment. The apparatus 100 comprises a dielectric substrate 102 having a (bottom) wear surface 104 and a (front) patterned surface 106 adjacent to the wear surface 104. The term “adjacent” used herein means that the wear surface and the patterned surface have a common boundary or edge. The dielectric substrate 102 may be made of glass, silicon, SiO₂, epoxy, a polymer, a semiconductor, ceramics, SiC, a nonconducting polymer (e.g., poly(3,4-ethylenedioxythiophene) (PEDOT), poly(azobenzene) (PAz), PEDOT: poly(styrene sulfonate) (PEDOT: PSS), etc.), a nonconducting co-polymer, indium tin oxide (ITO), fluorine doped tin oxide (FTO), carbon nanotubes (CNT), graphene, nanowire meshes, silver nanowires, generally any transparent conducting films (TCF) or transparent conducting oxides (TCO), or any combination of the aforesaid. The apparatus 100 further comprises an array 108 of conductors extending parallel to each other on the patterned surface 106 of the dielectric substrate 102. More specifically, each conductor of the array 108 of conductors has a planar straight-line shape and extends perpendicular to the wear surface 104. The name of the patterned surface 106 is caused exactly by that it has such a conductor pattern formed thereon. Preferably, each conductor of the array 108 of conductors may be made of a ductile material. The examples of the ductile material include, but not limited to, gold, silver, aluminum, copper, titanium, hafnium, nickel, zirconium, or any alloy or combination thereof, as well as any conducting polymer (e.g., PEDOT, PAZ, PEDOT:PSS, etc.), conducting co-polymer, ITO, or any semiconductor material belonging to groups III-V of Mendeleev's periodic table (e.g., Ge, Si). A layer of dielectric material (not shown in FIG. 1) is provided on the patterned surface 106 of the dielectric substrate 102 such that it covers not only each conductor of the array 108 of conductors but also each inter-conductor spacing. Given this, the structure formed by each two adjacent conductors the and dielectric material therebetween may be considered as a capacitor. The inter-conductor spacing may range from about 5 nm to about 10 mm, or may vary within any subranges of this spacing range, such, for example, as from about 10 nm to about 9 mm, from about 20 nm to about 8 mm, from about 30 nm to about 7 mm, from about 40 nm to about 6 mm, from about 50 nm to about 5 mm etc. Moreover, each conductor of the array 108 of conductors may have a width and thickness both falling within the same range from about 5 nm to about 10 mm or within any subranges of this range (e.g., like the ones indicated above in respect of the inter-conductor spacing). In general, the lower limit of this range is determined by the capabilities of the existing fabrication technologies, such as lithography (e.g., photolithography), 3D-printing, atomic layer deposition (ALD), Chemical Vapor Deposition (CVD), Ultra-High Vacuum CVD (UHV-CVD), Chemical Beam Epitaxy (CBE), laser ablation, Extreme ultraviolet (EUV) lithography, electron lithography, sputtering, electrolytic deposition (e. g., electroplating), etc. As for the upper limit of this range, it is mainly determined by what spacing is practical in a particular sensor application.

Let us now give one example of how to form the array 108 of aluminum conductors (and, if required, aluminum contact pads for the conductors) on the patterned surface 106 of the dielectric substrate 102 represented by a SiO₂ substrate. The aluminum conductors may be formed by sputtering a 100 nm thick layer of aluminum onto the SiO₂ substrate. After sputtering, the aluminum-coated SiO₂ substrate is covered with a positive photoresist (e.g., Positiv-20). The photoresist is then exposed to ultraviolet (UV) light for 5 minutes using a proper patterned photomask. After said exposure, the photoresist is developed using 1% NaOH, after which the layer of aluminum is etched using a phosphoric acid-based aluminum etchant. Finally, the whole sample is cleaned with acetone to remove the leftover photoresist. Subsequently, a layer of (e. g., any other dielectric material epoxy, or dielectric material, or any combination of dielectric materials) may be formed on the SiO₂ substrate such that the aluminum conductors and the spacings therebetween are covered with the layer of dielectric material.

Those skilled in the art would recognize that the above-given example of the sample fabrication does not limit anyhow the present disclosure. In some other embodiments, any other lithography techniques (e.g., those based on using X-rays, gamma rays of electron beams instead of UV or extreme UV (EUV) light) may be used to prepare the same conductor pattern on the patterned surface 106 of the dielectric substrate 102. As one more non-restrictive example, the same conductor pattern may be formed by using any of direct laser writing, multiphoton lithography, soft lithography, or nanoimprint lithography; each of these techniques allows one to obtain relatively thick conductors, while still providing precise patterning of the conductors.

As also shown in FIG. 1, the apparatus 100 further comprises a control unit 110 coupled to each conductor of the array 108 of conductors via a contact connector 112. Any existing contact connector may be used, which allows many conductors or wires to be individually coupled to a certain measurement device (like the control unit 110). In one alternative embodiment, wire bonding or a similar technique for connecting the array 108 of conductors with the control unit 110 may be used instead of forming the actual contact connector directly on the dielectric substrate 102; in this case, each conductor of the array 108 of conductors may have a contact pad at its one end (the contact pad is a wider area of the conductor which allows a bonding wire to be mounted thereon). In another alternative embodiment, if advanced lithography, an UHV chamber, or MBE is used to make the wear sensor 100, at least part (e.g., measurement means) of the control unit 110 may be provided directly on the dielectric substrate 102 (e.g., on the patterned surface 106 of the dielectric substrate 102).

As for the control unit 110, it may comprise a display, a processor and a memory coupled to the processor. The memory may store processor-executable instructions which, when executed by the processor, cause the processor to determine a wear rate within a wear path (see the solid arrow in FIG. 1), as will be discussed below in more detail.

The processor may be implemented as a CPU, general-purpose processor, memristor, neuromorphic computing chip, Artificial Intelligence (AI) chip (also referred to as AI hardware), single-purpose processor, microcontroller, microprocessor, application specific integrated circuit (ASIC), field programmable gate array signal (FPGA), digital processor (DSP), complex programmable logic device, etc. It should be also noted that the processor may be implemented as any combination of one or more of the aforesaid. As an example, the processor may be a combination of two or more microprocessors.

The memory may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), memristor, optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, non-volatile Resistive RAM (RRAM), Resistive (ReRAM), Spin Torque Transfer Magneto-resistive (STT-MRAM), Phase-Change Memory (PCM), etc.

The processor-executable instructions stored in the memory may be configured as a computer-executable program code which causes the processor to perform the aspects the present disclosure. The computer-executable program code for carrying out operations or steps for the aspects of the present disclosure may be written in any combination of one or more programming languages, such as Java, C++, Python, or the like. In some examples, the computer-executable program code may be in the form of a high-level language or in a pre-compiled form and be generated by an interpreter (also pre-stored in the memory) on the fly. In other examples, if the processor is implemented as an AI chip or a neuromorphic computing chip, the computer-executable program code may be generated by the AI chip or the neuromorphic computing chip on the fly.

The display may be implemented as a liquid-crystal display (LCD), light-emitting diode (LED) display, organic LED (OLED) display, microLED display, plasma display, backlight screen, front light screen, smart window, smart glass, etc.

It should be noted that the display may be excluded from the control unit 110. Instead, the control unit 110 may further comprise a transceiver, with the aid of which the control unit 110 may be configured to provide working results (i.e., the wear rate) to a user mobile device (e.g., via a mobile application installed on a user mobile phone) by using any available wireless communication standard (e.g., Bluetooth, Near-Field Communications (NFC), Radio Frequency Identification (RFID), Zigbee, LoRaWAN, WiFi, 4G/5G/6G, etc.).

The operational principle of the wear sensing apparatus 100 is as follows.

At first, the dielectric substrate 102 may be attached to or otherwise arranged near a wear-prone object of interest (e.g., a machine or tool component, a material sample to be subjected to surface finishing, such as polishing, etc.) such that the dielectric substrate 102 is exposed to the same wear process as the object of interest (i.e., the dielectric substrate 102 is machined/grinded/abraded with (or against) the object of interest). Said attachment or arrangement may be implemented by a variety of ways. For example, there may be a cavity formed on the wear surface of the object of interest, and the dielectric substrate 102 may be installed in this cavity such that the wear surface 104 faces against the wear direction. As another example, the dielectric substrate 102 may be adhered near the wear surface of the object of interest such that the wear surface 104 faces against the wear direction.

When wear occurs on the wear surface 104 of the dielectric substrate 102, it is gradually abraded, thereby leading to gradual abrasion of the conductors on the patterned surface 106. Due to this abrasion, the conductor lengths and the area between some adjacent conductors may change, which causes a change in corresponding selective capacitances. For example, it is well-known that the capacitance of a plate capacitor is directly proportional to a surface area of its plates, so the rate of the capacitance change is directly proportional to the rate of the surface area decrease. In this case, the plates are replaced with the adjacent conductors, and the rate of their length decrease depends on the wear rate of the wear surface 104.

During the wear on the wear surface 104, the unit 110 is configured to monitor the control capacitance of each capacitor formed on the patterned surface 106 of the dielectric substrate 102 (i.e., each structure formed by the two adjacent conductors and the dielectric material therebetween). Then, the control unit 110 is configured to use the monitored capacitances to determine a wear rate (or, in other words, a wear depth) of the dielectric substrate 102 within a wear path (see the solid arrow in FIG. 1). The control unit 110 is further configured to output (e.g., via the display) the wear rate to a user.

As noted above, the wear may be accompanied by the smearing effect. In FIG. 1, it is assumed that the smearing effect causes the occurrence of a thin layer 114 of plastic surface deformation. This may result in the situation when at least some of the conductors of the array 108 of conductors may be brought into direct electric contact in the proximity of the wear surface 104. In one embodiment, the control unit 110 may be further configured to use the monitored capacitances to detect the occurrence of such short circuits between the conductors during the wear. Moreover, the control unit may be further configured to output a signal (e.g., visual, acoustic, vibration, or any combination thereof) indicative of the occurrence of the short circuits between the conductors to the user.

It should be noted that the short circuits between the conductors may be also caused not only by the smearing effect but also if the object of interest (to which the dielectric substrate 102 is attached, or near which the dielectric substrate 102 is arranged such that it is exposed to the same wear process as the object of interest) is made of a conducting material. In this case, to distinguish between the short circuits (or direct electric contacts) caused by the smearing effect and the contact of the conductors with the conducting material, one may move the conducting object of interest along the wear surface 104 or otherwise move it away from the wear surface 104. The smearing-induced direct electric contacts will remain constant even after removing the contact with the conducting object of interest. For example, in case of using a machining (usually metal) tool to perform surface machining of a sample, the wear sensor 100 may be arranged on or near the sample such that the wear surface 104 of the dielectric substrate 102 is also machined with the tool; in this example, the direct electric contact between the tool and the wear sensor 100 may cause the short circuits between the conductors of the wear sensor 100. When the tool moves away, the smearing-induced direct electric contacts will remain constant, while the tool-induced direct electric contacts will disappear. Furthermore, for example, when monitoring the smearing effect in polishing processes, a polishing pad is not as conducting as smearing-induced inter-conductor contacts.

In one embodiment, the array 108 of conductors may have an equal inter-conductor spacing. The equal inter-conductor spacing may allow the user to monitor the wear rate (and the smearing effect, if present) in percentage terms. In another embodiment, the array 108 of conductors may have a varying inter-conductor spacing. The varying inter-conductor spacing may allow the user to monitor the wear rate (and the smearing effect, if present) in length units (e.g., in microns). It should be noted that the varying inter-conductor spacing may be especially useful for smearing-effect monitoring.

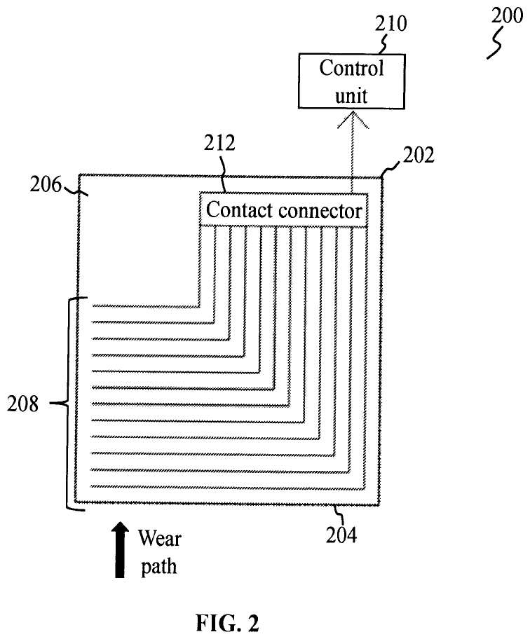

FIG. 2 shows a schematic block diagram of a wear sensing apparatus 200 in accordance with a second exemplary embodiment. The apparatus 200 comprises a dielectric substrate 202 having a (bottom) wear surface 204 and a (front) patterned surface 206 adjacent to the wear surface 204. The dielectric substrate 202 may be made of the same material as the dielectric substrate 102. The apparatus 200 further comprises an array 208 of conductors extending parallel to each other on the patterned surface 206 of the dielectric substrate 202. More specifically, each conductor of the array 208 of conductors comprises a first planar straight-line portion extending perpendicular to the wear surface 204 and a second planar straight-line portion extending parallel to the wear surface 204. Similar to the conductors of the apparatus 100, the conductors of the apparatus 200 may be made of a ductile material by using any existing lithography technique (e.g., in accordance with the above-given example of the sample fabrication). Similarly, a layer of dielectric material (not shown in FIG. 2) is provided on the patterned surface 206 of the dielectric substrate 202 such that it covers not only each conductor of the array 208 of conductors but also each inter-conductor spacing. The inter-conductor spacing may again range from about 5 nm to about 10 mm, or may vary within any subranges of this spacing range, such, for example, as from about 10 nm to about 9 mm, from about 20 nm to about 8 mm, from about 30 nm to about 7 mm, from about 40 nm to about 6 mm, from about 50 nm to about 5 mm, etc. Moreover, each conductor of the array 208 of conductors may again have a width and thickness both falling within the same range from about 5 nm to about 10 mm or any subranges of this range (e.g., like the ones indicated above in respect of the inter-conductor spacing).

As also shown in FIG. 2, the apparatus 200 further comprises a control unit 210 coupled to each conductor of the array 208 of conductors via a contact connector 212. Any existing contact connector may be used, which allows many conductors or wires to be individually coupled to a certain measurement device (like the control unit 210). In one alternative embodiment, wire bonding or a similar technique for connecting the array 208 of conductors with the control unit 210 may be used instead of forming the actual contact connector directly on the dielectric substrate 202; in this case, each conductor of the array 208 of conductors may have a contact pad at its one end, to which a bonding wire is mounted. In another alternative embodiment, if advanced lithography, an UHV chamber, or MBE is used to make the wear sensor 200, at least part (e. g., measurement means) of the control unit 210 may be provided directly on the dielectric substrate 202 (e.g., on the patterned surface 206 of the dielectric substrate 102).

As for the control unit 210, it may be implemented in the same manner as the control unit 110, as well as may be configured to operate in the same manner as the control unit 110. More specifically, the control unit 210 may be configured to monitor the capacitance of each capacitor formed on the patterned surface 206 of the dielectric substrate 202 (i.e., each structure formed by the two adjacent conductors and the dielectric material therebetween), determine the wear rate of the dielectric substrate 202 within the wear path (see the solid arrow in FIG. 2) based on the monitored capacitances, and output the wear rate to the user. The control unit 210 may be also configured to detect and monitor the smearing effect in the same manner as the control unit 110. For example, the smearing effect may result in the situation when the second (parallel) portion of the conductor closest to the wear surface 204 will be brought into direct electric contact with the second (parallel) portion of the next conductor.

It should be noted that the configuration of the array 208 of conductors allows one to simultaneously monitor a general wear depth by detecting how many conductors have “lost” their second portions (parallel to the wear surface 204) during wear on the wear surface 104. If one conductor “loses” its second portion, it will lead to a major loss of the mutual capacitance between this conductor and the next conductor. In turn, the configuration of the array 108 of conductors allows one to determine the wear rate by monitoring a decrease in the mutual capacitance between each two adjacent conductors, which probably gives less accurate results.

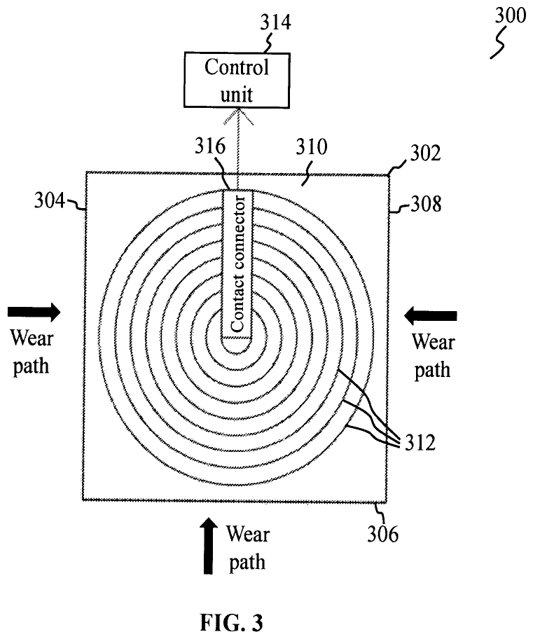

FIG. 3 shows a schematic block diagram of a wear sensing apparatus 300 in accordance with a third exemplary embodiment. The apparatus 300 comprises a dielectric substrate 302 having more than one wear surface, namely: a left-side wear surface 304, a bottom wear surface 306, and a right-side wear surface 308. Thus, unlike the dielectric substrates 102 and 202, the dielectric substrate 302 is intended to be abraded on two or three sides. The dielectric substrate 302 also has a (front) patterned surface 310 adjacent to each of the wear surfaces 304, 306, and 308. The dielectric substrate 302 may be made of the same material as the dielectric substrate 102. The apparatus 300 further comprises an array 312 of conductors extending parallel to each other on the patterned surface 310 of the dielectric substrate 302. More specifically, each conductor of the array 312 of conductors comprises has a planar circular shape. Similar to the conductors of the apparatus 100, the conductors of the apparatus 300 may be made of a ductile material by using any existing lithography technique (e.g., in accordance with the above-given example of the sample fabrication). Similarly, a layer of dielectric material (not shown in FIG. 3) is provided on the patterned surface 310 of the dielectric substrate 302 such that it covers not only each conductor of the array 312 of conductors but also each inter-conductor spacing. The inter-conductor spacing may again range from about 5 nm to about 10 mm, or may vary within any subranges of this spacing range, such, for example, as from about 10 nm to about 9 mm, from about 20 nm to about 8 mm, from about 30 nm to about 7 mm, from about 40 nm to about 6 mm, from about 50 nm to about 5 mm, etc. Moreover, each conductor of the array 312 of conductors may again have a width and thickness both falling within the same range from about 5 nm to about 10 mm or within any subranges of this range (e.g., like the ones indicated above in respect of the inter-conductor spacing). It is the combination of the circular conductor configuration and the layer of dielectric material which enables the capacitance measurements on two or more sides of the dielectric substrate 302.

As also shown in FIG. 3, the apparatus 300 further comprises a control unit 314 coupled to each conductor of the array 312 of conductors via a contact connector 316. Any existing contact connector may be used, which allows many conductors or wires to be individually coupled to a certain measurement device (like the control unit 314). In one alternative embodiment, wire bonding or a similar technique for connecting the array 312 of conductors with the control unit 314 may be used instead of forming the actual contact connector directly on the dielectric substrate 302; in this case, each conductor of the array 312 of conductors may have a contact pad at its one end, to which a bonding wire is mounted. In another alternative embodiment, if advanced lithography, an UHV chamber, or MBE is used to make the wear sensor 300, at least part (e.g., measurement means) of the control unit 314 may be provided directly on the dielectric substrate 302 (e.g., on the patterned surface 310 of the dielectric substrate 302).

As for the control unit 314, it may be implemented in the same manner as the control unit 110, as well as may be configured to operate in the same manner as the control unit 110. More specifically, the control unit 314 may be configured to monitor the capacitance of each capacitor formed on the patterned surface 310 of the dielectric substrate 302 (i.e., each structure formed by the two adjacent conductors and the dielectric material therebetween), determine the wear rate of the dielectric substrate 302 within each wear path (see the solid arrows in FIG. 3) based on the monitored capacitances, and output the wear rate to the user. The control unit 314 may be also configured to detect and monitor the smearing effect in the same manner as the control unit 110. For example, the smearing effect may result in the situation when the outermost circular conductor (closest to each of the wear surfaces 304, 306, and 308) will be brought into direct electric contact with the next circular conductor in one or more points.

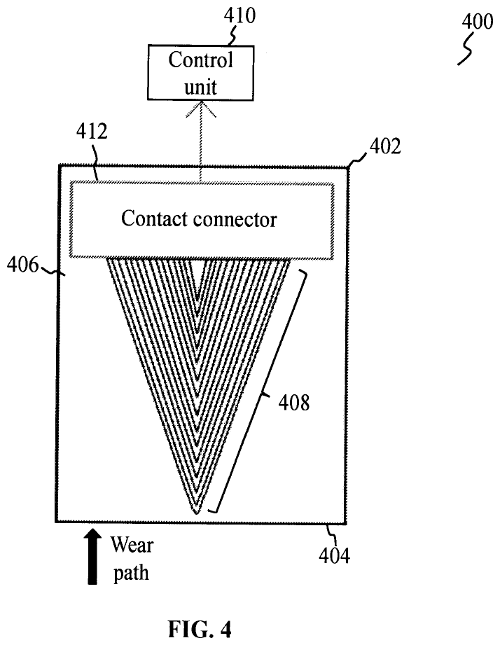

FIG. 4 shows a schematic block diagram of a wear sensing apparatus 400 in accordance with a fourth exemplary embodiment. The apparatus 400 comprises a dielectric substrate 402 having a (bottom) wear surface 404 and a (front) patterned surface 406 adjacent to the wear surface 404. The dielectric substrate 402 may be made of the same material as the dielectric substrate 102. The apparatus 400 further comprises an array 408 of conductors extending parallel to each other on the patterned surface 406 of the dielectric substrate 402. More specifically, each conductor of the array 408 of conductors has a planar triangular shape. Similar to the conductors of the apparatus 100, the conductors of the apparatus 400 may be made of a ductile material by using any existing lithography technique (e.g., in accordance with the above-given example of the sample fabrication). Similarly, a layer of dielectric material (not shown in FIG. 4) is provided on the patterned surface 406 of the dielectric substrate 402 such that it covers not only each conductor of the array 408 of conductors but also each inter-conductor spacing. The inter-conductor spacing may again range from about 5 nm to about 10 mm, or may vary within any subranges of this spacing range, such, for example, as from about 10 nm to about 9 mm, from about 20 nm to about 8 mm, from about 30 nm to about 7 mm, from about 40 nm to about 6 mm, from about 50 nm to about 5 mm, etc. Moreover, each conductor of the array 408 of conductors may again have a width and thickness both falling within the same range from about 5 nm to about 10 mm or within any subranges of this range (e.g., like the ones indicated above in respect of the inter-conductor spacing).

As also shown in FIG. 4, the apparatus 400 further comprises a control unit 410 coupled to each conductor of the array 408 of conductors via a contact connector 412. Any existing contact connector may be used, which allows many conductors or wires to be individually coupled to a certain measurement device (like the control unit 410). In one alternative embodiment, wire bonding or a similar technique for connecting the array 408 of conductors with the control unit 410 may be used instead of forming the actual contact connector directly on the dielectric substrate 402; in this case, each conductor of the array 408 of conductors may have a contact pad at its one end, to which a bonding wire is mounted. In another alternative embodiment, if advanced lithography, an UHV chamber, or MBE is used to make the wear sensor 400, at least part (e. g., measurement means) of the control unit 410 may be provided directly on the dielectric substrate 402 (e.g., on the patterned surface 406 of the dielectric substrate 402).

As for the control unit 410, it may be implemented in the same manner as the control unit 110, as well as may be configured to operate in the same manner as the control unit 110. More specifically, the control unit 410 may be configured to monitor the capacitance of each capacitor formed on the patterned surface 406 of the dielectric substrate 402 (i.e., each structure formed by the two adjacent triangular conductors and the dielectric material therebetween), determine the wear rate of the dielectric substrate 402 within the wear path (see the solid arrow in FIG. 4) based on the monitored capacitances, and output the wear rate to the user. The control unit 410 may be also configured to detect and monitor the smearing effect in the same manner as the control unit 110. For example, the smearing effect may result in the situation when the first (when counted from the wear surface 404) two adjacent triangular conductors may be brought into direct electric contact in the proximity of the triangle vertices.

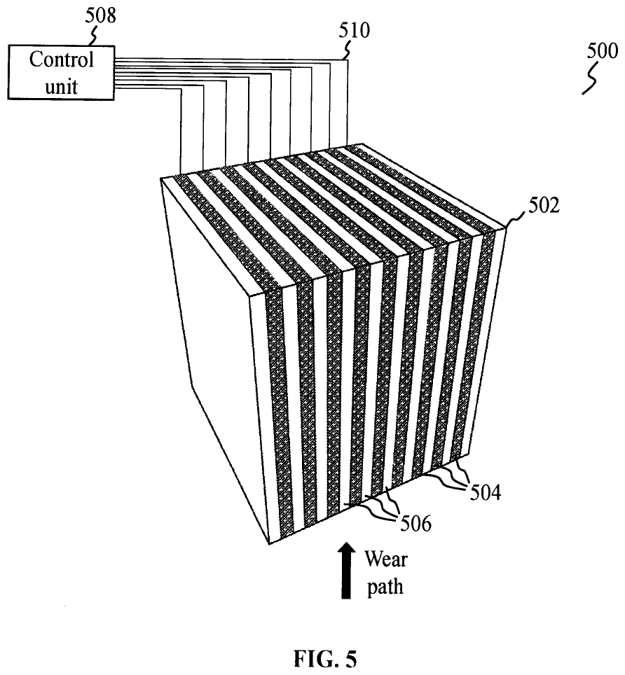

FIG. 5 shows a schematic block diagram of a wear sensing apparatus 500 in accordance with a fifth exemplary embodiment. The apparatus 500 comprises a substrate 502 configured as a multi-layered structure which is formed by plate-like conductors 504 alternating with dielectric layers 506. In this multi-layered structure, it is assumed that a wear surface (not shown in FIG. 5) is a bottom one, and the plate-like conductors 504 (and, consequently, the dielectric layers 506) are arranged parallel to each other and perpendicular to the wear surface. In other words, the wear surface is formed by the edges of the alternating plate-like conductors 504 and dielectric layers 506. In other embodiments, the wear surface may be any of the top, front and back surfaces of the multi-layered structure 502, each of which is formed (like the bottom surface) by the edges of the alternating plate-like conductors 504 and dielectric layers 506, as can be seen from FIG. 5.

Moreover, the perpendicular arrangement of the plate-like conductors 504 (and, consequently, the dielectric layers 506) relative to the wear surface should not be construed as any limitation of the present disclosure and may be replaced with the arrangement at which the plate-like conductors 502 (and, consequently, the dielectric layers 506) are tilted relative to the wear surface (e.g., the tilting angle may vary between 1 and 90 degrees). Thus, the multi-layered substrate 502 may be shaped differently, for example, as a cube (see FIG. 5) or a parallelepiped (if the plate-like conductors 502 and the dielectric layers 506 are tilted relative to the wear surface).

The dielectric layers 506 may be made of the same material as the dielectric substrate 102 by using any film and/or coating formation technology. For example, each of the dielectric layers 506 may also be formed by spin-coating a thin (e.g., 20 μm) layer of non-conductive glue on one plate-like conductor 504 and then attaching the plate-like conductor 504 to another plate-like conductor 504 such that the spin-coated layer of non-conductive glue is sandwiched therebetween.

Similar to the conductors of the apparatus 100, the conductors 504 of the apparatus 500 may be made of a ductile material. The inter-conductor spacing (or, in other words, the width of each dielectric layer 506) may again range from about 5 nm to about 10 mm, or may vary within any subranges of this spacing range, such, for example, as from about 10 nm to about 9 mm, from about 20 nm to about 8 mm, from about 30 nm to about 7 mm, from about 40 nm to about 6 mm, from about 50 nm to about 5 mm, etc. Moreover, each plate-like conductor 504 may have a width falling within the same range from about 5 nm to about 10 mm or within any subranges of this range (e.g., like the ones indicated above in respect of the inter-conductor spacing). In general, the substrate 502 may be fabricated by using any deposition technique that allows one to stack alternating conductor and dielectric layers.

As also shown in FIG. 5, the apparatus 500 further comprises a control unit 508 coupled to each plate-like conductor 504 via a corresponding bonding wire 510. In one alternative embodiment, instead of the bonding wires 510, any existing contact connector may be used, which allows many plate-like conductors to be individually coupled to a certain measurement device (like the control unit 508).

As for the control unit 508, it may be implemented in the same manner as the control unit 110, as well as may be configured to operate in the same manner as the control unit 110. More specifically, the control unit 508 may be configured to monitor the capacitance of each capacitor present in the multi-layered substrate 502 (i.e., each structure formed by the two adjacent plate-like conductors 504 and the dielectric layer 506 therebetween), determine the wear rate of the multi-layered substrate 502 within the wear path (see the solid arrow in FIG. 5) based on the monitored capacitances, and output the wear rate to the user. The control unit 508 may be also configured to detect and monitor the smearing effect in the same manner as the control unit 110. For example, the smearing effect may result in the situation when some or each two adjacent plate-like conductors 504 may be brought into direct electric contact in the proximity of the bottom wear surface.

The apparatus 500 is especially advantageous in terms of smearing effect detection and monitoring. In each of the apparatuses 100-400, there is only a thin layer of conducting material (i.e., planar conductors) formed on the patterned surface, for which reason it would be difficult for the smearing effect to “move” the conducting material so that at least two conductors are brought into direct electric contact. This is because there is a little amount of the conducting material which may be smeared in the first place. Conversely, in the multi-layered structure used in the apparatus 500, the smearing effect would be more pronounced because there is a larger wear surface with the conductor material that is able to be smeared.

It should be noted that the present disclosure is not limited to the conductor configurations shown in FIGS. 1-5. In some other embodiments, any other conductor configurations are possible. For example, each conductor may have any other curved shape, such as trapezoidal, square, etc., which allows the conductors to be formed on the patterned surface of the dielectric substrate with no initial direct contact therebetween. As another example, each conductor may comprise a first portion and a second portion that originate from a single point and diverge in a direction away from the wear surface (the triangular conductor shape shown in FIG. 4 is one particular example of such configuration).

Furthermore, in some embodiments, the inter-conductor spacing may increase or decrease within the wear path(s). For example, the array of conductors (any of those shown in FIGS. 1-5) may comprise two (first and second) non-overlapping subarrays of conductors, each of which may have a different inter-conductor spacing. For example, the first subarray of conductors may have a first equal inter-conductor spacing and the second subarray of conductors may have a second equal inter-conductor spacing different from the first equal inter-conductor spacing. Alternatively, the first subarray of conductors may have an equal inter-conductor spacing, while the second subarray of conductors may have a varying inter-conductor spacing. Furthermore, in case of the arrays of conductors shown in FIGS. 2-4, the first and second subarray of conductors may be arranged differently relative to the wear surface(s) (e.g., the first subarray of conductors may be provided closer to each wear surface than the second subarray of conductors, or vice versa).

In some additional embodiments, the apparatuses 100-500 may further comprise an accelerometer and/or a gyroscope mounted on the dielectric substrates 102-502, respectively (e.g., in case of the apparatus 100, on the patterned surface 106 in the proximity of the array 108 of conductors; in case of the apparatus 500, on any surface(s) other than the wear surface of the multi-layered substrate 502). For example, the combination of the accelerometer and the gyroscope may be implemented by using the Micro-Electromechanical Systems (MEMS) technology. The accelerometer and/or the gyroscope may have a built-in transmitter (e.g., a Bluetooth transmitter) to be able to transmit measurement data to a mobile user device (e.g., via a mobile application installed on a mobile phone).

In some additional embodiments, the control unit included in each of the apparatuses 100-500 may be configured to determine the wear rate (and detect the smearing effect, if present) by taking resistance measurements in addition to or instead of the above-described capacitance measurements. That is, the control unit of each of the apparatuses 100-500 may monitor a resistance between each two adjacent conductors, determine the wear rate of the corresponding substrate based on the monitored resistances and/or the capacitance measurements, and output the wear rate to the user. For example, with reference to FIG. 5, this means that the control unit 508 may be configured to monitor the resistance between each two adjacent plate-like conductors 504, determine the wear rate of the multi-layered substrate 502 based on the monitored resistances and/or capacitances, and output the wear rate to the user.

As for the smearing effect, it may be detected by using the resistance measurements, for example, as follows. As an example, let us consider the apparatus 500, but the following considerations are also true for the apparatuses 100-400. A near-zero resistance means there is a direct contact between the adjacent plate-like conductors 504, which is likely caused by the smearing effect (e.g., a metallic bridge is formed across the dielectric layer 506 due to the smearing effect). A large resistance means there is no direct contact between the adjacent plate-like conductors 504, thereby implying no smearing effect occurred across the dielectric layer 506. The capacitance measurements and the resistance measurements allow one to determine the on/off state of the smearing effect (i.e., whether the metallic bridge is formed across the dielectric layer 506). In addition, the capacitance measurements and the resistance measurements also give some intermediate values (i.e., a continuous measurement signal) which may be used to determine how “strong” the smearing-caused contact is or, in other words, how large and continuous the metallic bridge is. In general, the resistance measurements are all-sufficient, i.e., the wear rate and the smearing effect may be measured based on them only (this is because measuring something with resistance may be much easier than with capacitance). However, by using the resistance measurements in combination with the capacitance measurements, it is possible to increase the accuracy of detecting the amount of the smearing effect.

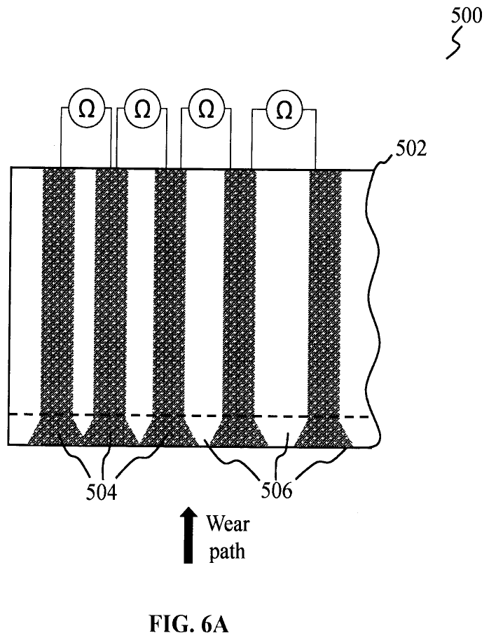

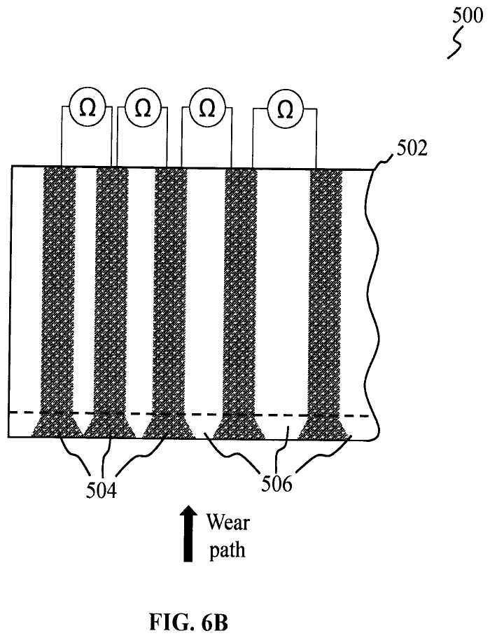

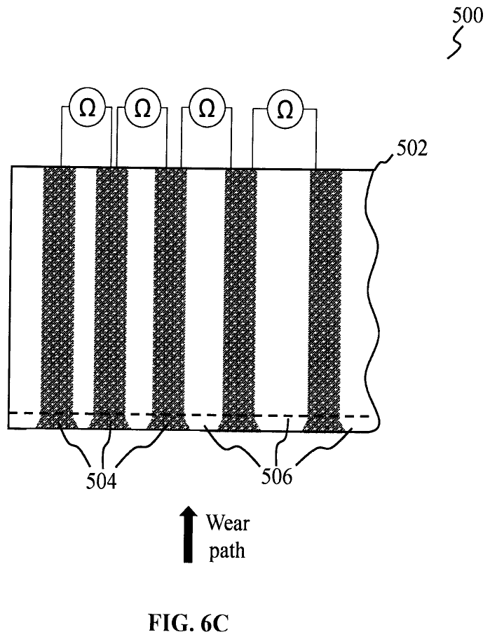

FIGS. 6A-6C schematically show how the resistance measurements may be used to monitor the smearing effect that manifests as metallic bridges across the dielectric layers 506 in the apparatus 500. The following considerations are also true for the apparatuses 100-400. It is assumed that the inter-conductor spacing varies (i.e., increases) from left to right in the apparatus 500, and the smearing effect manifests “evenly” across the whole (bottom) wear surface. This means that the plate-like conductors 504 will be short-circuited gradually from left to right in the apparatus 500 as the smearing effect increases (i.e., the plate-like conductors 504 having smaller “gaps” therebetween will be short-circuited first). The smearing effect may be caused, for example, due to coarse abrasion applied to the (bottom) wear surface of the apparatus 500 (e.g., during machining, chemical mechanical planarization, cutting, grinding, lapping, polishing, or materialographic sample preparation). As a result of the coarse abrasion, there are two metallic bridges: one connecting the first and second two plate-like conductors 504 and another connecting the second and third plate-like conductors 504 (see FIG. 6A). In other words, the first and second plate-like conductors 504 are short-circuited, as well as the second and third plate-like conductors 504 are short-circuited, which may be detected by taking the resistance measurements, as described above (i.e., when a near-zero resistance is measured between two adjacent plate-like conductors 504). The dashed horizontal line shown in FIGS. 6A-6C indicates an assumed depth of abrasion-induced plastic deformation or, in other words, the smearing effect along the wear surface. In FIG. 6B, it is implied that the metallic bridge between the second and third plate-like conductors 504 disappears due to fine abrasion (or polishing) applied to the (bottom) wear surface of the apparatus 500. As the fine abrasion continues, the metallic bridge between the first and second plate-like conductors 504 also disappears, which is shown in FIG. 6C. Thus, the application of the fine abrasion after the coarse abrasion allows the apparatus 500 to “reset” in the sense that it is ready to be used again in a new wear process. Furthermore, the varying inter-conductor spacing and the use of different conductor materials may allow one to understand how to tune the parameters (e.g., a speed, force, duration, abrasive grain size, etc.) of the material removal process (e.g., grinding or polishing), if required.

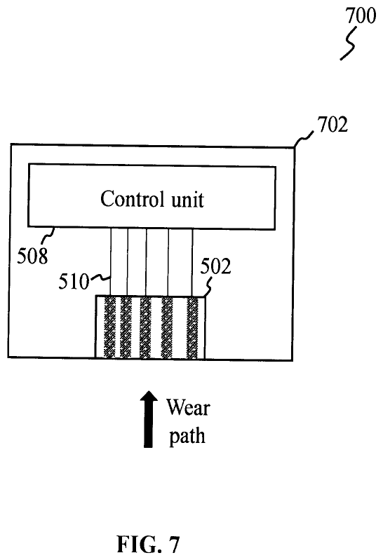

FIG. 7 shows how the apparatus 500 may be implemented in the form of a button-like structure 700. The structure 700 comprises the apparatus 500 inside a housing 702, so that the wear surface of the apparatus 500 is aligned with one surface of the housing 702 (e.g., the bottom surface of housing 702, as shown in FIG. 7). That surface of the housing 702 and the wear surface of the apparatus 500 are assumed to be exposed to the same wear process (e.g., during machining, chemical mechanical planarization, cutting, grinding, lapping, polishing, or materialographic sample preparation). The housing 702 may be made, for example, as an epoxy (or some other resin) block with the apparatus 500 embedded therein such that the wear surface of the apparatus 500 is left exposed on one surface of the epoxy block. In other words, the apparatus 500 may be cast with epoxy (or some other resin) to form the structure 700. However, the present disclosure is not limited to this fabrication technique of the structure 700; in some embodiments, the housing 702 may be implemented as a hollow body having one side with an opening for the wear surface of the apparatus 500, and the apparatus 500 may be mounted inside the hollow body such that its wear surface is in the opening of the hollow body.

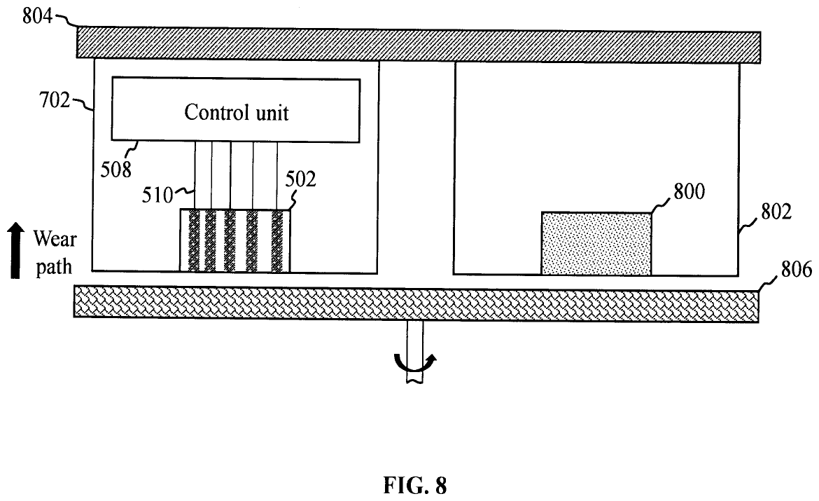

FIG. 8 shows how the button-like structure 700 may be used in a polishing process. It is assumed that the plate-like conductors 504 are made of the same material as a sample 800, or the plate-like conductors 504 are made of another wear-process applicable material, or the plate-like conductors 504 are made of at least two different wear-process applicable materials. The sample 800 is installed in a housing 802 in the same or similar manner as the apparatus 500 in the housing 702, and the housings 702 and 802 may have the same or similar dimensions. For example, each of the housings 702 and 802 may be implemented as an epoxy (or some other resin) block. In other words, each of the apparatus 500 and the sample 800 may be identically cast with epoxy (or some other resin) to form two similar button-like structure. These structures are then attached to a sample holder 804 such that the wear surfaces of the apparatus 500 and the sample 800 are exposed to the same wear process by using a polishing disk 806 (or any other polishing or abrasion means, such as a polishing cloth, etc.). For example, these structures may be attached to the sample holder 804 mechanically with the possibility of their free rotation (e. g., provided by sample mover plates in materialographic sample preparation), or they may be mechanically fixed without the possibility of free movement (e.g., provided by sample holder plates in materialographic sample preparation). These structures may also be attached to the sample holder 804 with vacuum or by using an adhesive (used, e.g., in chemical mechanical planarization). During the polishing process, a user may monitor the degree of the smearing effect the formation of undesired scratches by properly taking the resistance and/or capacitance measurements with the aid of the control unit 508 embedded in the housing 702 and, if required, properly tune the polishing process (e. g., changes a coarse polishing disk to a fine polishing disk if the former causes the significant smearing effect or undesired scratches). For example, the control unit 508 may be equipped with a wireless transceiving unit configured to provide a corresponding signal to the user (e.g., his/her mobile phone).

It should be also noted that the resistance measurements and the capacitance measurements may be used, individually or in combination, to determine a relative change in a moisture content on the wear surface during the wear process. This is relevant for polishing operations, in which the moisture content on a polishing cloth/surface is measured by utilizing the electrical properties (e.g., dielectric and/or conducting properties) of a polishing suspension. In this case, the resistance measurements may be taken in the same manner as described above with reference to the smearing effect. That is, the polishing suspension causes a lower resistance between the adjacent conductors (e.g., the adjacent plate-like conductors 504) touching the wear surface to be monitored. By analyzing how the resistance changes during the polishing operations, it is possible to monitor the relative change in the moisture content.

Moreover, machine-learning (ML) algorithms (e.g., neural networks, decision trees, regression models, etc.) may be integrated into each of the apparatuses 100-500. For example, during a wear process, the control unit included in each of the apparatuses 100-500 may feed the measured resistance and/or capacitance between each two adjacent conductors to a ML algorithm which, in turn, may be configured to predict whether to make changes in the parameters of the wear process (e. g., whether type of grinding or polishing should be changed from “coarse” to “fine” to speed up the process of materialographic sample preparation or chemical mechanical planarization, or to minimize the occurrence of the undesired smearing effect, etc.). For this prediction, the ML model may be pre-trained by using historical data, such as past resistance and/or capacitance measurements taken for a certain conductor material and a certain inter-conductor spacing.

Although the exemplary embodiments of the present disclosure are described herein, it should be noted that various changes and modifications could be made in these embodiments, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. A wear sensing apparatus comprising:
a multi-layered substrate having a wear surface, the multi-layered substrate comprising an array of plate-like conductors and an array of dielectric layers, the array of plate-like conductors and the array of dielectric layers alternating with each other, and the wear surface being formed by edges of plate-like conductors of the array of plate-like conductors and edges of dielectric layers of the array of dielectric layers; and
a control unit coupled to each plate-like conductor of the array of plate-like conductors and configured, when wear occurs on the wear surface, to:
monitor a capacitance and/or a resistance between each two adjacent plate-like conductors of the array of plate-like conductors;
based on the monitored capacitances and/or the monitored resistances, determine a wear rate of the multi-layered substrate; and
output the wear rate to a user.

2. The apparatus of claim 1, wherein the control unit is further configured to:
based on the monitored capacitances and/or the monitored resistances, determine whether at least two plate-like conductors of the array of plate-like conductors have been brought into a direct electric contact during the wear; and
if the at least two plate-like conductors of the array of plate-like conductors have been brought into the direct electric contact during the wear, output a signal to the user.

3. The apparatus of claim 1, wherein each plate-like conductor of the array of plate-like conductors extends perpendicular to the wear surface.

4. The apparatus of claim 1, wherein the array of plate-like conductors has an equal inter-conductor spacing.

5. The apparatus of claim 1, wherein the array of plate-like conductors has a varying inter-conductor spacing.

6. The apparatus of claim 4, wherein the inter-conductor spacing ranges from about 5 nm to about 10 mm, more preferably from about 10 nm to about 9 mm, from about 20 nm to about 8 mm, from about 30 nm to about 7 mm, from about 40 nm to about 6 mm, or from about 50 nm to about 5 mm.

7. The apparatus of claim 1, wherein the array of plate-like conductors comprises a first subarray of plate-like conductors and a second subarray of plate-like conductors, the first subarray of plate-like conductors and the second subarray of plate-like conductors being non-overlapping, the first subarray of plate-like conductors having an equal inter-conductor spacing and the second subarray of plate-like conductors having a varying inter-conductor spacing.

8. The apparatus of claim 7, wherein the inter-conductor spacing of each of the first subarray of plate-like conductors and the second subarray of plate-like conductors ranges from about 5 nm to about 10 mm, more preferably from about 10 nm to about 9 mm, from about 20 nm to about 8 mm, from about 30 nm to about 7 mm, from about 40 nm to about 6 mm, or from about 50 nm to about 5 mm.

9. The apparatus of claim 1, wherein the array of plate-like conductors comprises a first subarray of plate-like conductors and a second subarray of plate-like conductors, the first subarray of plate-like conductors and the second subarray of plate-like conductors being non-overlapping, the first subarray of plate-like conductors having a first equal inter-conductor spacing and the second subarray of plate-like conductors having a second equal inter-conductor spacing, the second equal inter-conductor spacing being different from the first equal inter-conductor spacing.

10. The apparatus of claim 9, wherein each of the first equal inter-conductor spacing and the second equal inter-conductor spacing ranges from about 5 nm to about 10 mm, more preferably from about 10 nm to about 9 mm, from about 20 nm to about 8 mm, from about 30 nm to about 7 mm, from about 40 nm to about 6 mm, or from about 50 nm to about 5 mm.

11. The apparatus of claim 1, wherein each plate-like conductor of the array of plate-like conductors is made of a ductile material.

12. The apparatus of claim 1, wherein each dielectric layer of the array of dielectric layers is made of glass, silicon, SiO₂, epoxy, a polymer, a semiconductor, ceramics, SiC, a nonconducting polymer, a nonconducting copolymer, or any combination thereof.

13. The apparatus of claim 1, wherein each plate-like conductor of the array of plate-like conductors has a width ranging from about 5 nm to about 10 mm, more preferably from about 10 nm to about 9 mm, from about 20 nm to about 8 mm, from about 30 nm to about 7 mm, from about 40 nm to about 6 mm, or from about 50 nm to about 5 mm.

14. The apparatus of claim 1, further comprising at least one of an accelerometer and a gyroscope on at least one surface of the multi-layered substrate that is other than the wear surface.
